(19) United States
(12) Patent Application Publication
(10) Pub. No.: US 2008/0216531 A1
(43) Pub. Date: Sep. 11, 2008

(54) Locking apparatus

(75) Inventors: Andrew William Waller, Romford (GB); Joe Robert Charnley, Brentwood (GB)

Correspondence Address: DRINKER BIDDLE & REATH;ATTN: INTELLECTUAL PROPERTY GROUP, ONE LOGAN SQUARE, 18TH AND CHERRY STREETS, PHILADELPHIA, PA, 19103-6996, US

(73) Assignee: Borg Locks Limited, Brentwood (GB)

(21) Appl. No.: 12/072,201

(22) Filed: Feb. 25, 2008

(30) Foreign Application Priority Data
Feb. 26, 2007 (GB) 0703663.5

(51) Int. Cl. E05B 37/16

(52) U.S. Cl. 70/298

(57) ABSTRACT

The invention relates to locking apparatus such as a door combination lock. The apparatus includes a lock housing having a number of code entry buttons mounted on its face. The buttons allow a user to enter a code combination in order to gain access through the door. In order to prevent deciphering of the code by an unauthorised user a load plate is provided to selectively impede actuation of the buttons between a released and a depressed configuration.

### FIELD OF THE INVENTION

The present invention relates to locking apparatus, particularly, but not exclusively to locking apparatus for use on a mechanical combination door lock.

### BACKGROUND OF THE INVENTION

It is desirable in many applications to allow building entry doors, windows, cupboards etc. to be opened only by those who have been authorised to do so. One way of achieving this is to use a locking mechanism which requires a predetermined code to be entered before it can be unlocked. Mechanical combination door locks are widely used for this purpose. Such locks typically have a series of alphanumeric buttons (often 4, 6 or 8) and a knob or handle which can be grasped by the user. In operation, the code is dialed into the mechanism by the authorised user, the knob or handle is turned and the mechanism unlocks. However, it has been discovered that it is possible for users to decipher the code from the mechanism itself as follows:
a. Before attempting to press any of the alphanumeric buttons, the unauthorised user rotates the knob or handle a few degrees until further rotation is resisted. The knob or handle is linked to the coding mechanism which results in pressure being applied to the components of the coding mechanism which are linked to the buttons;
b. The user then gently presses each of the buttons on the locking mechanism. The unauthorised user is able to determine the code relatively easily by identifying which buttons have a different level of resistance to being pushed;
c. Once the full code has been identified by the unauthorised user, he then removes the rotational pressure on the knob or handle;
d. The unauthorised user can then enter the correct code into the mechanism, turn the knob or handle and gain unauthorised access.

This situation is clearly undesirable since it negates the purpose of having a coded entry system.

### SUMMARY OF THE INVENTION

According to the present invention, there is provided locking apparatus operated by a code entry mechanism, the locking apparatus comprising:

a lock mechanism provided with a plurality of code entry buttons which are actuable between a released configuration and a depressed configuration;

wherein a load plate is provided, the load plate being actuable between an inactive configuration in which it allows actuation of the buttons, and an active configuration in which it impedes actuation of the buttons.

Typically, spacing gaps are provided between the base of the code entry buttons and the mechanism when the buttons are in the released configuration.

Preferably, the load plate is provided with a plurality of obstruction members which correspond with the plurality of code entry buttons such that when the load plate is actuated to its active configuration, the obstruction members reside at least partially in the spacing gaps in order to impede actuation of the buttons between the released and depressed configurations. The thickness of the obstruction members, and the load plate may be designed to be only very slightly less than the height of the spacing gaps in order to minimise depression of any of the buttons by a user when the load plate is in the active configuration.

With this arrangement when the load plate impedes actuation of the buttons a user pressing any of the buttons will feel an equal amount of resistance on each button and will therefore be unable to determine the code of the locking apparatus.

The load plate may alternatively be designed to actuate into frictional abutment with side walls of the buttons in order to at least partially impede depression thereof by a user.

Preferably, actuation means is linked to the load plate in order to actuate the load plate between the inactive and active configurations. Preferably, the actuation means comprises a drive member and a driven member each having gears which are meshed together.

The drive member may be integrated into a knob or handle used by the user to unlock a locking bolt of the lock.

The driven member preferably comprises a crescent shaped gear having a centre shaft about which it rotates, and at least a drive pin offset from the centre shaft. The drive pin may bear against a bearing surface of the load plate in order to actuate the load plate from its inactive configuration into its active configuration. Preferably, such a drive pin is provided on either side of the centre shaft in order to allow actuation of the load plate from its in active configuration to its active configuration when the drive member is rotated in either a clockwise or an anti-clockwise direction.

A chamber sliding plate is also typically provided and is preferably driven by an opposite end of the or each drive pin on the driven member.

### BRIEF DESCRIPTION OF THE DRAWINGS

Embodiments of the present invention will now be described, by way of example only, with reference to the following drawings, in which:

FIG. 1 is a schematic front view of the locking apparatus according to the present invention with the front cover removed in order to show the inner mechanisms of the apparatus. This view shows the load plate in the inactive configuration;

FIG. 2 is a schematic front view of the apparatus of FIG. 1 where the load plate has been actuated to its active configuration;

FIG. 3 is a perspective view of a chamber sliding plate of the apparatus of FIG. 1;

FIG. 4 is a perspective view of the load plate of the apparatus of FIG. 1;

FIG. 5 is a plan view of the load plate of the apparatus of FIG. 1;

FIG. 6 is a more detailed plan view of the driven member of the apparatus of FIG. 1;

FIG. 7 is a plan view from beneath the chamber sliding plate of FIG. 3; and

FIG. 8 is a perspective view of the driven member of the apparatus of FIG. 1.

### DETAILED DESCRIPTION OF THE PREFERRED EMBODIMENT

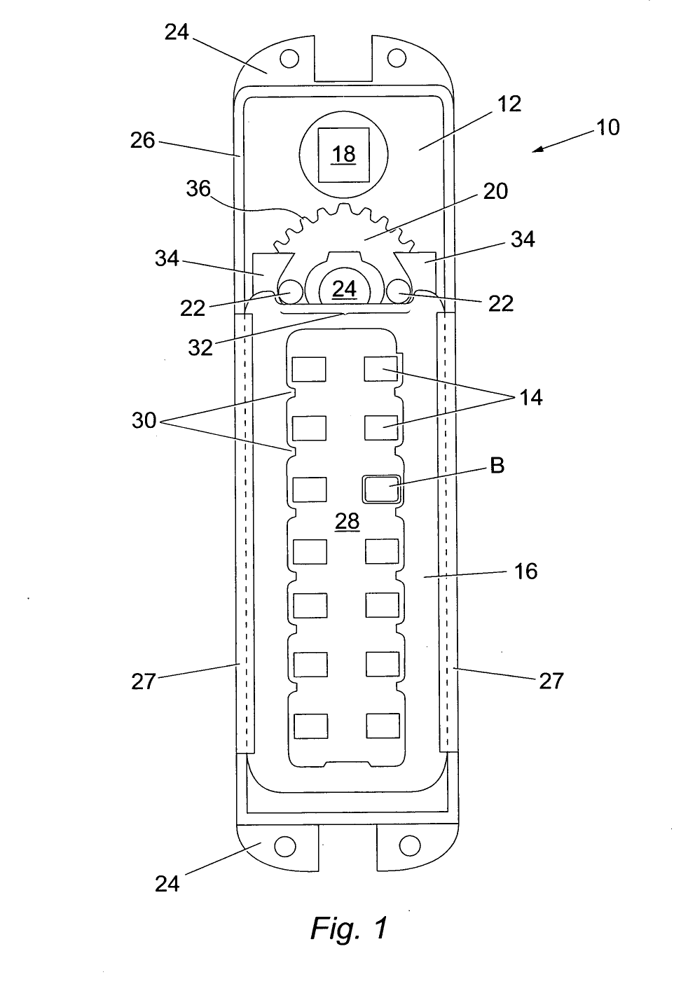

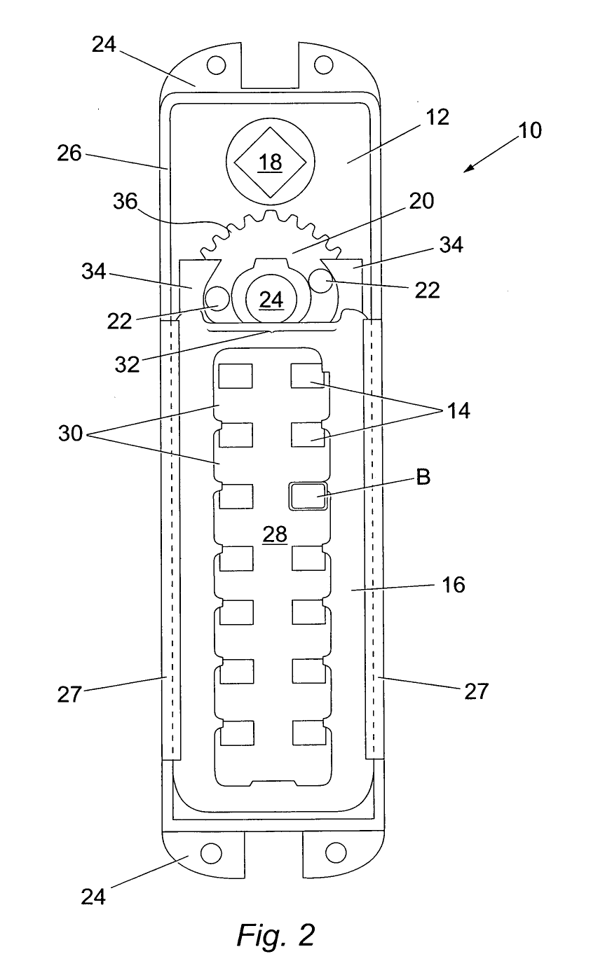

With reference to FIGS. 1 and 2, locking apparatus 10 comprises a lock housing 12 with a matrix of code entry mechanisms 14 of known configuration. When fully constructed, each code entry mechanism 14 is covered by a button B which can be pressed by the user in order to enter the required code into the mechanism. In order to maximise the clarity of the attached drawings only one of the code entry mechanisms 14 is covered with a button B. A load plate 16 surrounds the code entry mechanism 14 matrix. Provided towards the top of the housing 12 are actuation means comprising a drive member 18 and a driven gear member 20 which has a pair of drive pins 22 on either side of a centre shaft 24. The drive pins 22 project through both sides of the driven member 20 as illustrated in FIG. 8.

In the embodiment shown, the lock housing 12 is formed from cast metal or another suitable material. The housing 12 is integrated into a single unit having upper and lower attachment portions 24 and raised side walls 26 extending around the perimeter of the housing 12. The housing 12 may also be provided with thickened wall portions and strengthening ribs (not shown) in order to increase the strength and security of the apparatus. Portions of the side walls 26 are formed into longitudinal retaining lips 27 which project inwardly from either side of the housing 12 in order to retain the load plate 16 within the housing 12 during translation of the load plate 16 between its inactive and active configurations. This is described in more detail subsequently.

Each button B comprises a flat pressing portion which has parallel side walls extending there from. As will be appreciated by the skilled reader, the base of each button side wall does not sit flush on the housing when the buttons B are mounted on each corresponding code entry mechanisms 14 of the matrix. Instead each button will sit up from the housing by small distance. This is due to the nature of the mechanisms 14 which require movement of this distance in order to register a keystroke of the button B. There is therefore a small spacing gap between the base of the button B side walls and the portion of the housing on which the matrix of code entry mechanisms 14 are provided.

Load plate 16 surrounds the code entry mechanism 14 matrix and includes a rectangular frame having a corresponding central window 28. The central window 28 has a series of obstruction members 30 projecting inwardly from the inner periphery of the frame, the purpose of which will be described subsequently. The top of the load plate 16 has an indentation therein to provide a bearing surface 32. An additional corner obstruction 31 is provided on one of the inner corners of the frame.

The drive member 18 of the actuation means has a circular shaft with a centralised square indexing protrusion. This allows the drive member 18 to be linked with a rotation knob (not shown) which projects through to the front of the outer casing in order to allow the user to rotate the drive member 18. The drive member 18 is also provided with gear teeth (not visible in FIGS. 1 and 2) which mesh with gear teeth 36 of the driven member 20. A pair of drive pin guides 34 are also provided on either side of the driven member 20.

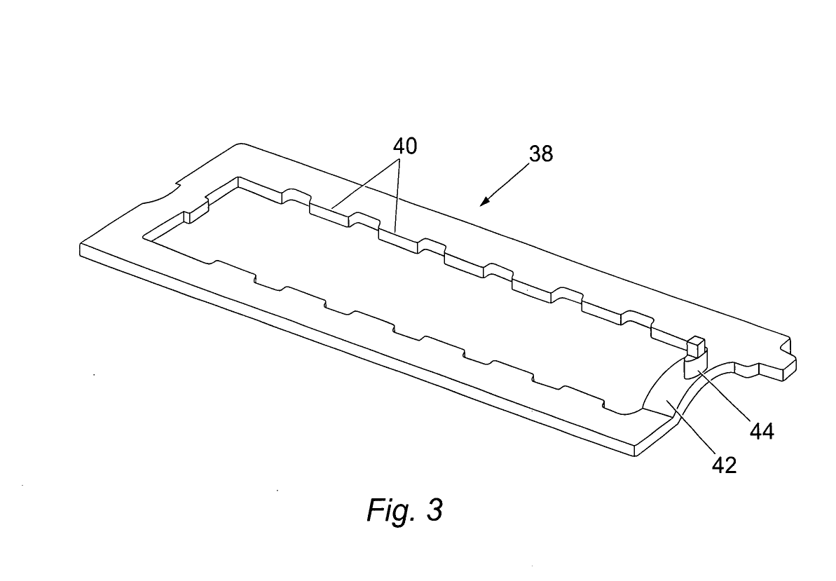

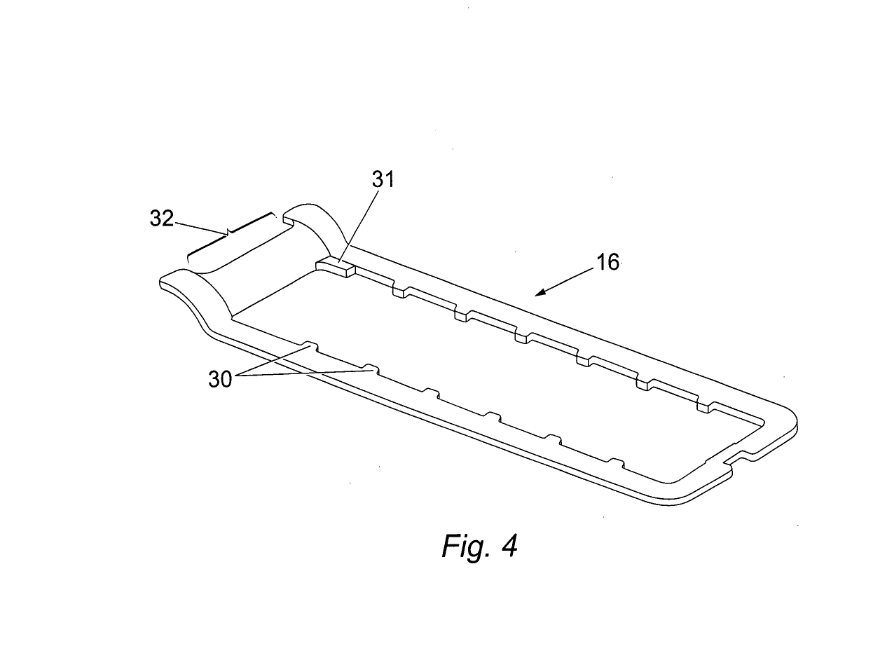

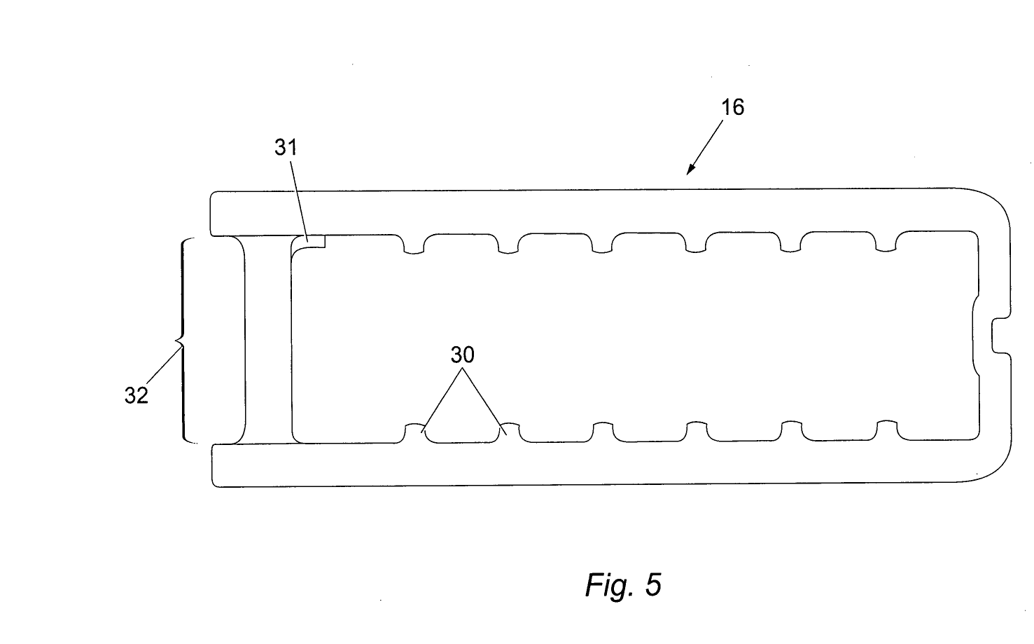

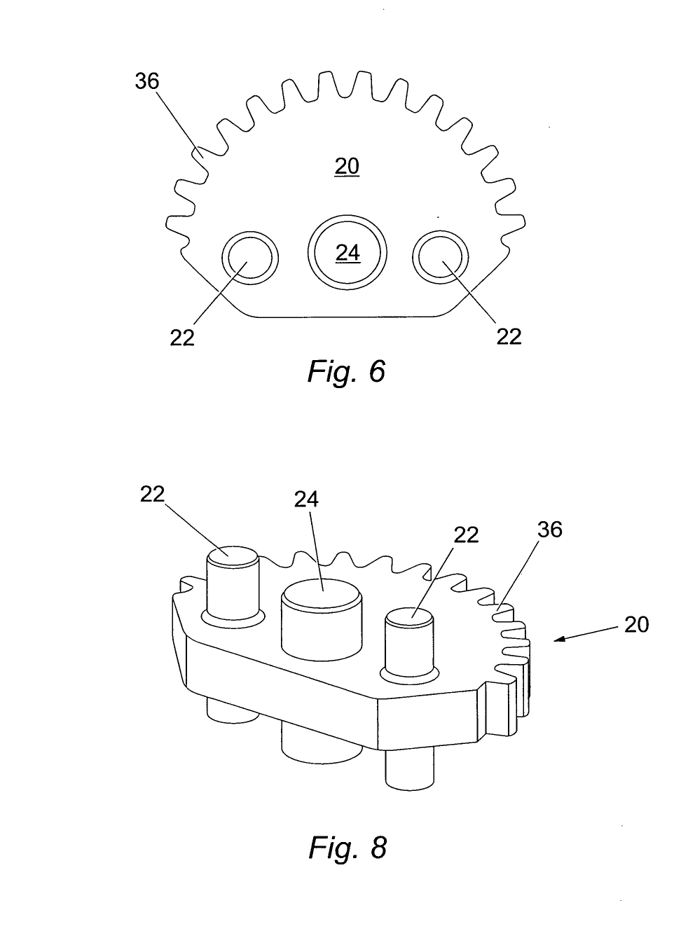

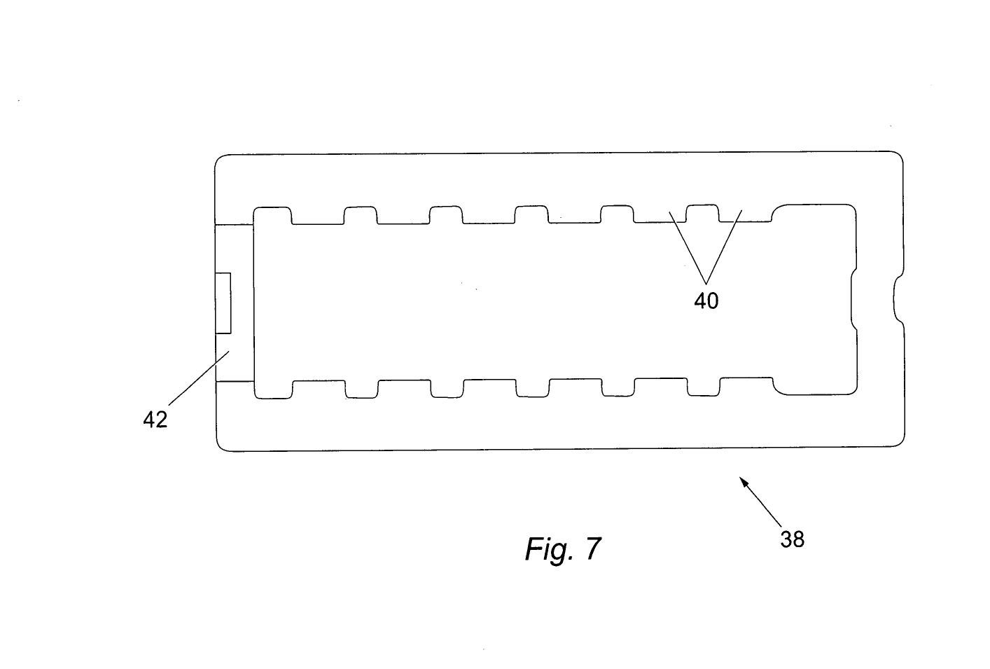

With reference to FIGS. 3 and 7, a chamber sliding plate 38 is provided behind the load plate 16 (and hence is not visible in FIGS. 1 and 2) and surrounds the rear of code entry mechanism 14 matrix. The chamber sliding plate 38 has a frame similar to the load plate 16, however it has the inward protrusions 40 are greater in length. The top of the chamber sliding plate 38 also has an arched protrusion 42 with a locating ridge 44. This formation allows the chamber sliding plate 38 to mate with the load plate 16 around the code entry mechanism matrix 14.

In use, when an authorised user wishes to open the lock, he first enters the correct code into the mechanism. Since the correct code has been entered he is able to rotate the drive member 18 by rotating a knob or handle on the lock casing. This causes the chamber sliding plate 38 to move (behind the matrix) until the door unlocks. As this occurs the load plate 16 will also move into an active position; however, it will only do so when the user turns the driven member 18. Since this occurs after the correct code has been entered, the load plate 16 does not interfere with normal operation of the locking apparatus.

Operation of the load plate 16 when an unauthorised user attempts to open the locking apparatus using the deciphering technique previously outlined will now be described.

In an attempt to determine the code the unauthorised user first turns the drive member 18 (by way of a knob or handle) with the belief that doing so will help determine the access code. In the example illustrated by FIGS. 1 and 2, the knob is turned clockwise, however, it will be appreciated by the skilled reader that the locking apparatus 10 functions equally well regardless of whether the drive member 18 is rotated in a clockwise or anti-clockwise direction. As the drive member 18 is rotated clockwise the gearing between the drive member 18 and the driven member 20 causes the driven member to rotate anti-clockwise around its central shaft 24. As this occurs, the left hand drive pin 22, which is fixed to the driven member 20, pushes down on the bearing surface 32 of the load plate 16. The planetary motion of the drive pins 22 around the central shaft 24 is assisted by the drive pin guides 34. This action causes the load plate 16 to translate down the housing 12, as shown in FIG. 2. In this regard, it should be noted that although only one side of the load plate 16 is being pushed by the drive pin 22, the load plate 16 will move linearly down the housing 12 and is discouraged from rotating within the housing 12 due to its close fit with the internal width of the housing 12 and the guiding action of the retaining lips 27.

As the load plate 16 enters this active position each obstruction member 30 enters the gap between the side walls of the adjacent button B and the housing. Obstruction member 31 in the inner corner of the plate also enters the gap under the side walls of the top corner button. No obstruction member equivalent to the corner obstruction member 31 is provided on the opposite side of the frame in the embodiment shown. This allows a “clear” button to be pressed even when the plate is in the active position. With the obstruction members in place, the stroke distance for each button B from the released position to the de-pressed deposition is removed. This means that when the user attempts to gently press any of the buttons B he will simply feel the same level of resistance regardless of whether a particular button B corresponds with a coded entry mechanism 14 or an un-coded entry mechanism 14. The system therefore provides a dislocation of the relationship between the coding of the mechanism 14 matrix and the resistance of the buttons B from being pressed. The unauthorised user is therefore unable to determine the code of the system and is therefore unable to gain unauthorised access.

Resilient means such as a spring and/or the inherent resilience within the coding chamber ensures that the locking apparatus 10 is urged back to the inactive, neutral position once the user releases the rotational force from the drive member 18.

Modifications and improvement may be made to the foregoing, without departing from the scope of the invention, for example:

Rather than requiring obstruction members 30 to be moved between the buttons B and the housing, another way of providing the dislocation between the coding of the mechanism and the resistance of the buttons B from being pressed is to use frictional resistance rather than obstruction. In such an arrangement, protrusions from a load plate could be provided with a gripping surface which simply abuts against the side walls of the buttons B.

The load plate 16 may be provided with an additional centre spar spanning lengthways across the central window 28. This may also be provided with obstruction members corresponding to the obstruction members 30. This allows the plate 16 to provide additional support to the buttons B when the load plate 16 is in the active configuration since the buttons will be supported by the obstruction members at each corner and hence will not be able to be tilted when pressed.

1. Locking apparatus operated by a code entry mechanism, the locking apparatus comprising:
a lock mechanism provided with a plurality of code entry buttons which are actuable between a released configuration and a depressed configuration;
wherein a load plate is provided, the load plate being actuable between an inactive configuration in which it allows actuation of the buttons, and an active configuration in which it impedes actuation of the buttons.

2. Locking apparatus according to claim 1, wherein spacing gaps are provided between the base of the code entry buttons and the mechanism when the buttons are in the released configuration.

3. Locking apparatus according to claim 2, wherein the load plate is provided with a plurality of obstruction members which correspond with the plurality of code entry buttons such that when the load plate is actuated to its active configuration, the obstruction members reside at least partially in the spacing gaps in order to impede actuation of the buttons between the released and depressed configurations.

4. Locking apparatus according to claim 3, wherein the thickness of the obstruction members, and the load plate are substantially similar to the thickness of the spacing gaps in order to minimise depression of any of the buttons by a user when the load plate is in the active configuration.

5. Locking apparatus according to claim 1, wherein the load plate comprises frictional abutment portions actuable into frictional abutment with side walls of the buttons in order to at least partially impede depression thereof by a user.

6. Locking apparatus according to claim 1, wherein an actuation means is linked to the load plate in order to actuate the load plate between the inactive and active configurations.

7. Locking apparatus according to claim 6, wherein the actuation means comprises a drive member and a driven member each having meshed gears.

8. Locking apparatus according to claim 7, wherein the drive member is integrated into a knob or handle used by the user to unlock a locking bolt of the lock.

9. Locking apparatus according to claim 7, wherein the driven member comprises a crescent shaped gear having a centre shaft about which it rotates, and at least a drive pin offset from the centre shaft.

10. Locking apparatus according to claim 9, wherein the drive pin may bear against a bearing surface of the load plate in order to actuate the load plate from its inactive configuration into its active configuration.

11. Locking apparatus according to claim 9, wherein the drive pin is provided on either side of the centre shaft in order to allow actuation of the load plate from its inactive configuration to its active configuration when the drive member is rotated in either a clockwise or a counter-clockwise direction.

12. Locking apparatus according to claim 1, wherein a chamber sliding plate is provided, the chamber slide plate being driven by an opposite end of the or each drive pin on the driven member.
